(19) United States
(12) Patent Application Publication
(10) Pub. No.: US 2012/0307033 A1
(43) Pub. Date: Dec. 6, 2012

(54) SYSTEM FOR DETERMINING USER ENGAGEMENT BEHAVIOR WITH A MULTIMEDIA INTERFACE IN A REAL TIME ENVIRONMENT AND A METHOD THEREOF

(75) Inventors: Normahdiah SHEIK SAID, Selangor Darul Ehsan (MY); Rahinah Ibrahim, Selangor Darul Ehsan (MY)

(73) Assignee: Universiti Putra Malaysia, Selangor Daml Ehsan (MY)

(21) Appl. No.: 13/490,032

(22) Filed: Jun. 6, 2012

(30) Foreign Application Priority Data
Jun. 6, 2011 (MY) PI 2011002564

(51) Int. Cl. H04N 9/47

(52) U.S. Cl. 348/77

(57) ABSTRACT

This invention is a system to determine a user's engagement behavior in a real time environment when the user is engaging with a multimedia interface. The system receives at least one selected score from at least one user, captures and stores the at least one received selected score, at least one facial expression of at least one user, at least one visual of the multimedia interface of the at least one user's engagement and the time of the at least one user's engagement. The data determines the user engagement behavior and is presented using a means of presenting data.

### FIELD OF INVENTION

The present invention relates to a system for determining user engagement behavior and a method thereof. More particularly, this invention relates to a system for determining a user engagement behavior with a multimedia interface in a real time environment and a method thereof.

### BACKGROUND OF INVENTION

Currently there are many designers involved in designing multimedia systems. Some multimedia systems have good interactive design features in them. Some of these system work well but there are others that fail wherein the users are not engaged when interacting with the multimedia systems. There are no specific rules for a designer to follow in designing multimedia systems that are engaging to end users.

PI 20091022 discloses a system for determining user behavior in multimedia systems based on designing features which exploit psychological needs. The system includes measuring of facial expression manually. The system measures the engagement by a certain scale and marks the engagement patterns. This is a very manual process and does not occur in a real time environment.

There is a need to provide for a solution in designing automated engaging system wherein measurement of the engagement is done in a real time environment.

### SUMMARY OF INVENTION

It is disclosed herein, a system for determining at least one user's engagement behavior with a multimedia interface in a real time environment, the system includes:
i. a means of receiving at least one score selected by the at least one user;
ii. a means of capturing at least one facial expression of the at least one user;
iii. a means of capturing at least one visual of the multimedia interface of the at least one user's engagement;
iv. a means of recording time of the at least one user's engagement;
v. a means of analyzing data of the at least one score selected by the at least one user, the at least one facial expression of the at least one user, the at least one visual of the multimedia interface of the at least one user's engagement and the time of the at least one user's engagement; and
vi. a means of presenting the data.

It is also disclosed herein, a method for determining at least one user's engagement behavior with a multimedia interface in a real time environment, the method includes the steps of:
i. receiving at least one score selected by the at least one user, capturing at least one facial expression of the at least one user and capturing at least one visual of the multimedia interface of the at least one user's engagement for a predetermined sequence of time;
ii. recording time of the at least one user's engagement;
iii. analyzing the data of the at least one score selected by the at least one user, the at least one facial expression of the at least one user, the at least one visual of the multimedia interface of the at least one user's engagement and the time of the at least one user's engagement; and
iv. presenting the data using a means of presenting data.

It is further disclosed herein, a method for determining at least one user engagement behavior with a multimedia interface in a real time environment, the method includes the steps of:
i. receiving at least one score selected by the at least one user, capturing at least one facial expression of the at least one user and capturing at least one visual of the multimedia interface of the at least one user's engagement for a predetermined sequence of time;
ii. analyzing the data of the at least one score selected by the at least one user, the at least one facial expression of the at least one user and the at least one visual of the multimedia interface of the at least one user's engagement; and
iii. presenting the data using a means of presenting data.

### BRIEF DESCRIPTION OF THE DRAWINGS

FIG. 1 illustrates a user interface of a preferred embodiment of the invention.

### DETAILED DESCRIPTION OF THE PREFERRED EMBODIMENTS

The present invention relates to a system for determining user engagement behavior with a multimedia interface in a real time environment and a method thereof. The system is a NEMD (Natural Observation and Reflection of Multimedia Application (NORMA) Engagement Multimedia Design Model) system. The invention and its various embodiments are better understood by reading the description along with the accompanying drawings which appear herein for purpose of illustration only and do not limit the invention in any way.

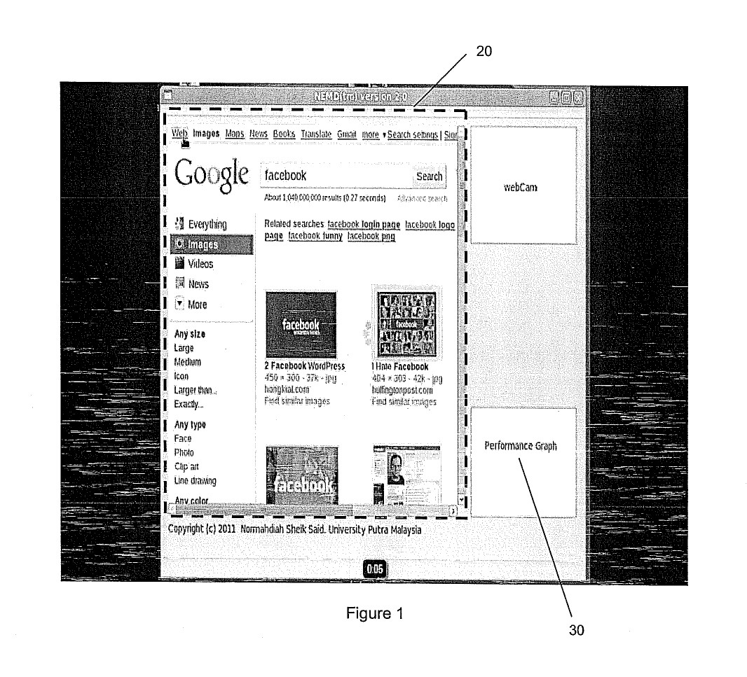

FIG. 1 illustrates an interface (20) of a multimedia system wherein a user is engaging with the interface (20). A screen displayed for a predetermined sequence of time allows the user to select a score from a scale of 1-10. The higher the score on the scale, the greater the degree of engagement felt by the user. A score of 10 at the top of the scale indicates a maximum degree of felt engagement wherein a zero indicates disengagement. The facial expression of the user before, during and after placing the score upon engaging with the multimedia interface (20) is captured in real time using a means of capturing image. The score and the scale are validated and calibrated in real time and used as a tool to determine level of engagement. The engagement of the user is displayed in real time using a means of presenting data (30).

The score and the captured facial expression of the user are stored in a centralized database wherein the data is easily retrievable. Visual of the multimedia interface (20) wherein the user is engaged to is also captured and stored. Time of the engagement is also recorded automatically and stored in the database. The data capturing is executed for a predetermined sequence of time preferably for a period of 40 minutes with a 5 minute interval for each capture. Gathered data is viewed at a real time or at a later time as preferred by a client.

Data including the score, facial expression, visual of the multimedia interface (20) and time of the engagement presents rise and fall time of engagement patterns so that clients can determine differentiation amongst engagement levels per multimedia interface (20) per facial expressions at every 5 minute interval wherein user engagement behavior is determined by the system as invented. Multimedia system designers determine performance of their multimedia system by performing analysis of the data captured and stored in the database.

Compilation of the data stored in the database helps designers and developers produce multimedia systems of better quality. Validly engaging system is developed by redesigning a part of an original system. The part that requires redesigning is determined by the data captured wherein the analyzed data may be represented in the means of presenting data (30). Any errors and/or failures in a multimedia system are detected and analyzed in real time.

The real time system can be customized according to a client's need wherein data representation is adjusted to suit clients. The clients include research universities, academicians and researchers in learning institutes such as schools, colleges and universities wherein personnel of these institutions may perform data analysis to determine harmful and/or addictive multimedia systems. Once the harmful and/or addictive systems are determined, rating stars are placed wherein the rating stars are guidelines for choosing the right systems for audiences wherein the audiences may include people of different age group (i.e. kids, teenagers, adults). The data may also be used to study cross culture transfers, language discourse analysis and market research consumerism activities. The real time system is a tool to help educational and training institutes to design engaging educational systems, and to help resource centres to develop engaging educational activities.

The system may also be used in research analysis for clients wherein the clients are in the website designing industry and also for designers of smart learning programs. The system may be used by multimedia developers wherein the system contributes to evaluate their design, revamp, improve or redesign, determine engagement standards and levels of engagement in the materials they have or about to create, to design an engaging educational multimedia experience on varying platforms such as info kiosks, web sites, and educational experiential learning environments.

Other educational stakeholders may use it as a tool to help educators, policy makers, curriculum designers, librarians, and resource centre personnel determine quality of engagement in the educational multimedia system they intend to purchase, to help parents to detect engagement rates of the multimedia system safe to purchase for their children according to age groups especially non-educational multimedia system and to help parents to choose good multimedia system that are both educational and engaging.

1. A system for determining at least one user's engagement behavior with a multimedia interface in a real time environment, the system comprising:
a means of receiving at least one score selected by the at least one user;
a means of capturing at least one facial expression of the at least one user;
a means of capturing at least one visual of the multimedia interface of the at least one user's engagement;
a means of recording time of the at least one user's engagement;
a means of analyzing data of the at least one score selected by the at least one user, the at least one facial expression of the at least one user, the at least one visual of the multimedia interface of the at least one user's engagement and the time of the at least one user's engagement; and
a means of presenting the data.

2. The system as claimed in claim 1 further comprising a means of storing the at least one score selected by the at least one user, the at least one facial expression of the at least one user, the at least one visual of the multimedia interface of the at least one user's engagement and the time of the at least one user's engagement.

3. A method for determining at least one user's engagement behavior with a multimedia interface in a real time environment, the method comprising:
receiving at least one score selected by the at least one user, capturing at least one facial expression of the at least one user and capturing at least one visual of the multimedia interface of the at least one user's engagement for a predetermined sequence of time;
recording a time of the at least one user's engagement;
analyzing the data of the at least one score selected by the at least one user, the at least one facial expression of the at least one user, the at least one visual of the multimedia interface of the at least one user's engagement and the time of the at least one user's engagement; and
presenting the data using a means of presenting data.

4. The method as claimed in claim 3 further comprising the step of storing the data of the at least one score selected by the at least one user, the at least one facial expression of the at least one user, the at least one visual of the multimedia interface of the at least one user's engagement and the time of the user's engagement in at least one database.

5. A method for determining at least one user engagement behavior with a multimedia interface in a real time environment, the method comprising the steps of:
receiving at least one score selected by the at least one user, capturing at least one facial expression of the at least one user and capturing at least one visual of the multimedia interface of the at least one user's engagement for a predetermined sequence of time;
analyzing the data of the at least one score selected by the at least one user, the at least one facial expression of the at least one user and the at least one visual of the multimedia interface of the at least one user's engagement; and
presenting the data using a means of presenting data.

6. The method as claimed in claim 5 comprising the step of storing the data of the at least one score selected by the at least one user, the at least one facial expression of the at least one user and the at least one visual of the multimedia interface of the at least one user's engagement in at least one database.
